(19) United States
(12) Patent Application Publication
(10) Pub. No.: US 2025/0260065 A1
(43) Pub. Date: Aug. 14, 2025

(54) LAMINATED BATTERY

(71) Applicant: TOYOTA JIDOSHA KABUSHIKI KAISHA, Toyota-shi (JP)

(72) Inventor: Yushi Suzuki, Mishima-shi (JP)

(73) Assignee: TOYOTA JIDOSHA KABUSHIKI KAISHA, Toyota-shi (JP)

(21) Appl. No.: 19/007,661

(22) Filed: Jan. 2, 2025

(30) Foreign Application Priority Data
Feb. 14, 2024 (JP) 2024-020380

(51) Int. Cl. H01M 10/0585; H01M 50/186

(52) U.S. Cl. CPC H01M 10/0585; H01M 50/186

(57) ABSTRACT

The present disclosure provides a laminated battery that has both reduced moisture deterioration and improved volumetric energy density. A laminated battery of the disclosure comprises a stack and a sealing material. A laminated battery of the disclosure has at least part of the stack, other than one outermost current collector, encapsulated by one outermost current collector through a sealing material, and has one outermost current collector covering the stack other than at one current collector, so that at least part of the outer perimeter edge of the other outermost current collector is covered by a sealing material. In other words, the other outermost current collector has at least part of a side where the active material is not stacked, which extends from at least part of the outer perimeter edge of the other outermost current collector, covered by one outermost current collector via the sealing material.

### FIELD

The present disclosure relates to a laminated battery.

### BACKGROUND

Lithium batteries are susceptible to degradation by moisture in the negative electrode active material layer and positive electrode active material layer and in the separator layer. Sealing materials are therefore provided to avoid infiltration of moisture into the negative electrode active material layer and positive electrode active material layer and into the separator layer.

The sealing material is generally provided on the outer periphery of the stack comprising the negative electrode active material layer, positive electrode active material layer and separator layer, sandwiching the stack and sealing material with a negative electrode collector and positive electrode collector. However, if there is insufficient contact area between the negative electrode collector and sealing material and/or insufficient contact area between the positive electrode collector and sealing material, then moisture may infiltrate through the interface between the negative electrode collector and sealing material and/or the interface between the positive electrode collector and sealing material, near the outer perimeter edges of the negative electrode collector and/or positive electrode collector. In order to avoid this situation it is effective to increase the contact area between the negative electrode collector and sealing material and/or the contact area between the positive electrode collector and sealing material, but this also increases the volume ratio of the sealing material which does not contribute to charge-discharge, thus lowering the volumetric energy density.
PTL 1, for example, discloses a thin battery in which the sealing material of a single battery is folded so as to cover the outer perimeter edges of the current collector of the single battery.
PTL 2 discloses a thin battery in which the entire battery is covered with a sealing material.

### CITATION LIST

### Patent Literature

[PTL 1] Japanese Unexamined Patent Publication No. 2019-21636
[PTL 2] Japanese Unexamined Patent Publication No. 2013-114929

### SUMMARY

### Technical Problem

In the thin battery disclosed in PTL 1, the sealing property is improved because the sealing material of the single battery is folded so as to cover the outer perimeter edges of the current collector of the single battery. However, since the sealing material of the single battery is folded so as to cover the outer perimeter edges of the current collector of the single battery, there has been a limit to how thin the battery as a whole can be made. When laminating the single battery of PTL 1, therefore, it has been difficult to make the laminated battery as a whole thinner, resulting in the problem of lower volumetric energy density.

With the thin battery disclosed in PTL 2, in which the entire battery is covered with the sealing material, there is a disadvantage in terms of thickness reduction at both edges in the stacking direction of the constituent elements of the battery, by the amount of the thickness of the sealing material, and therefore lower volumetric energy density has been a problem in this case as well.

The present inventors focused on the need for a laminated battery with both reduced moisture deterioration and improved volumetric energy density.

For the purpose of solving this problem, it is an object of the present disclosure to provide a laminated battery that has both reduced moisture deterioration and improved volumetric energy density.

### Solution to Problem

The present inventors have designed the laminated battery of the disclosure after conducting much research with the aim of solving the aforementioned problem. The aspects of the invention are as follows.

### <Aspect 1>

A laminated battery comprising:
a stack having a plurality of single batteries each with a negative electrode collector, a negative electrode active material layer, a separator layer, a positive electrode active material layer and a positive electrode collector stacked in that order, the batteries being stacked with the negative electrode collectors and the positive electrode collectors in mutual contact, and
a sealing material covering the outer side of the stack other than one outermost current collector of the stack,
wherein at least part of the stack other than at the one outermost current collector is encapsulated by the one outermost current collector through the sealing material, and the one outermost current collector covers the stack other than at the one current collector, so that at least part of the outer perimeter edge of the other outermost current collector is covered by the sealing material.

### <Aspect 2>

The laminated battery according to aspect 1, wherein the negative electrode collectors are connected together, or shared as a single negative electrode collector instead of mutual contact between the negative electrode collectors.

### <Aspect 3>

The laminated battery according to aspect 1 or 2, wherein the positive electrode collectors are connected together, or shared as a single positive electrode collector instead of mutual contact between the positive electrode collectors.

### <Aspect 4>

The laminated battery according to aspect 1 or 2, wherein the separator layer comprises a solid electrolyte.

### <Aspect 5>

The laminated battery according to aspect 3, wherein the separator layer comprises a solid electrolyte.

### Advantageous Effects of invention

In the laminated battery of the disclosure, at least part of the stack other than at the one outermost current collector is encapsulated by the one outermost current collector through the sealing material, and the one outermost current collector covers the stack other than at the one current collector, so that at least part of the outer perimeter edge of the other outermost current collector is covered by the sealing material. According to the present disclosure it is possible to provide a laminated battery that has both reduced moisture deterioration and improved volumetric energy density.

### BRIEF DESCRIPTION OF DRAWINGS

FIG. 1 is a schematic view showing an example of the cross-sectional structure of a laminated battery of the disclosure in overview.

FIG. 2 is a schematic diagram illustrating an example of a method for producing a laminated battery of the disclosure.

FIG. 3 is a cross-sectional diagram showing the section near one outermost negative electrode collector of FIG. 2.

FIG. 4 is a cross-sectional diagram showing the section near a negative electrode collector other than the one outermost negative electrode collector of FIG. 2.

FIG. 5 is a cross-sectional diagram showing the state just before main fusion of a sealing material.

### DESCRIPTION OF EMBODIMENTS

An embodiment of the laminated battery of the disclosure will now be explained in detail. However, the embodiment described below is not intended to limit the laminated battery of the disclosure.

The reason why the laminated battery of the disclosure achieves both reduced moisture deterioration and improved volumetric energy density will be explained based on knowledge of the present inventors, though without being constrained to any particular theory.

The laminated battery of the disclosure has at least part of the stack, other than one outermost current collector, encapsulated by one outermost current collector through a sealing material, and has one outermost current collector covering the stack other than at one current collector, so that at least part of the outer perimeter edge of the other outermost current collector is covered by a sealing material. In other words, the other outermost current collector has at least part of a side where the active material is not stacked, which extends from at least part of the outer perimeter edge of the other outermost current collector, covered by one outermost current collector via the sealing material.

As a result, at least part of the outer perimeter edge of each of the current collectors except one outermost current collector are covered with the sealing material. Specifically, the sealing property at the interface between the current collector and sealing material is improved in all of the current collectors except for the one outermost current collector.

The outer perimeter edge of the one outermost current collector, on the other hand, is not covered with a sealing material and thus has an inferior sealing property. However, even if moisture infiltrates through the interface between the one outermost current collector and the sealing material, the interface between the one outermost current collector and the sealing material is an interface on the opposite side of the stack from which the sections other than the one outermost current collector are encapsulated. This therefore does not affect moisture deterioration of the negative electrode active material layer and positive electrode active material layer, or the separator layer, which are present in the stack.

Moreover since folding of the sealing material is only at the section covering the outer perimeter edge of the other outermost current collector, it is possible to minimize increase in volume occupied by the sealing material caused by folding of the sealing material. This allows the volumetric energy density of the laminated battery to be increased.

For this reason, the laminated battery of the disclosure can exhibit both reduced moisture deterioration and improved volumetric energy density.

The constituent features of the laminated battery of the disclosure, devised based on this knowledge, will now be described with reference to the accompanying drawings.

### Laminated Battery

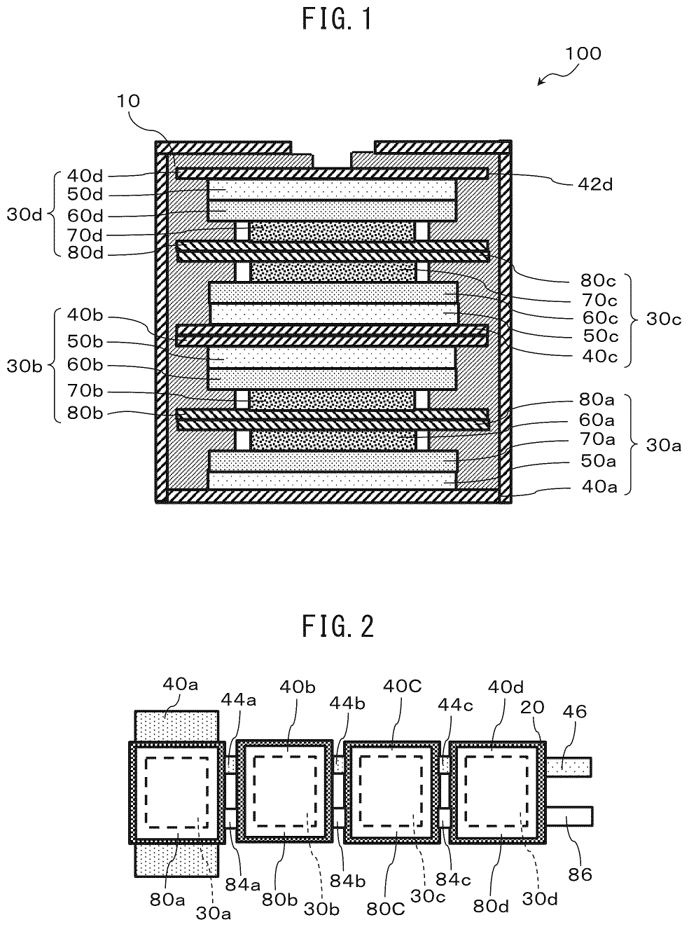

FIG. 1 is a schematic view showing an example of the cross-sectional structure of a laminated battery of the disclosure in overview. The laminated battery of the disclosure 100 comprises a stack 10 and a sealing material 20. The stack 10 and sealing material 20 will now be explained.

### Stack

A plurality of single batteries 30a 30b, 30c, 30d are stacked in the stack 10. Each single battery 30a has a negative electrode collector 40a, a negative electrode active material layer 50a, a separator layer 60a, a positive electrode active material layer 70a and a positive electrode collector 80a stacked in that order. The same applies for the single battery 30b, the single battery 30c and the single battery 30d.

For the aspect shown in FIG. 1, the plurality of single batteries 30a, 30b, 30c and 30d are stacked with the negative electrode collectors and positive electrode collectors in mutual contact, but there is no limitation to this mode. For example, they may be stacked with the negative electrode collectors connected so as to be shared as a single negative electrode collector. Likewise, they may be stacked with the positive electrode collectors connected so as to be shared as a single positive electrode collector. The connection method is not particularly restricted and may be pressure welding or ordinary welding, for example. Alternatively, they may be stacked with the negative electrode collectors shared as a single negative electrode collector instead of being in contact with each other. Likewise, they may be stacked with the positive electrode collectors shared as a single positive electrode collector instead of being in contact with each other.

### Negative Electrode Collector

The material used in the negative electrode collectors 40a, 40b, 40c, 40d is not particularly restricted, and any one that can be used as a negative electrode collector in a battery may be employed as appropriate. For example, the material used in the negative electrode collectors 40a, 40b, 40c, 40d may be, but is not limited to, stainless steel (SUS), aluminum, copper, nickel, iron, titanium or carbon, or a conductive resin. The material used for the negative electrode collectors 40a, 40b, 40c, 40d is preferably resistant to reduction, and is preferably nickel, for example.

### Negative Electrode Active Material Layer

The negative electrode active material layers 50a, 50b, 50c, 50d each comprise a negative electrode active material, and optionally a conductive aid and a binder. When the laminated battery of the disclosure is a solid-state battery, it may optionally comprise a solid electrolyte. The solid electrolyte forming the separator layer may be used in this case.

The material for the negative electrode active material is not particularly restricted, and it may be lithium metal, or any material capable of occluding and releasing metal ions such as lithium ions. Examples of materials capable of occluding and releasing metal ions such as lithium ion include, but are not limited to, alloy-based negative electrode active materials and carbon materials.

Alloy-based negative electrode active materials are not particularly restricted, and examples include Si alloy-based negative electrode active materials and Sn alloy-based negative electrode active materials. Si alloy-based negative electrode active materials include silicon, silicon oxides, silicon carbides, silicon nitrides, and their solid solutions. A Si alloy-based negative electrode active material may also include elements other than silicon, such as Fc, Co, Sb, Bi, Pb, Ni, Cu, Zn, Ge, In, Sn and Ti, for example. Sn alloy-based negative electrode active materials include tin, tin oxides, tin nitrides, and their solid solutions. A Sn alloy-based negative electrode active material may also include elements other than tin, such as Fe, Co, Sb, Bi, Pb, Ni, Cu, Zn, Ge, In, Ti and Si, for example. Si alloy-based negative electrode active materials are preferred among these.

Carbon materials are not particularly restricted, and include hard carbon, soft carbon and graphite, for example.

### Separator Layer

The material used in the separator layers 60a, 60b, 60c, 60d is not particularly restricted, and any one that can be used as a separator layer in a battery may be employed as appropriate. When the laminated battery of the disclosure is a solid-state battery, the separator layer may comprise a solid electrolyte and optionally a binder. Since a hot press is used in the step of producing the laminated battery of the disclosure in order to closely bond the sealing material 20 (described hereunder) at the necessary locations, the separator layer is preferably a solid electrolyte with high heat resistance, and especially a sulfide-based or oxide-based solid electrolyte.

The material of the solid electrolyte is not particularly restricted, and may be a solid sulfide electrolyte, a solid oxide electrolyte or a polymer electrolyte.

Examples of solid sulfide electrolytes include, but are not limited to, sulfide-based amorphous solid electrolytes, sulfide-based crystalline solid electrolytes and argyrodite solid electrolytes. Specific examples of solid sulfide electrolytes include, but are not limited to, Li₂S—P₂S₅ (Li₇P₃S₁₁, Li₃PS₄, Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂), LiI—Li₂S—P₂O₅, LiI—Li₃PO₄—P₂S₅ and Li₇₋ₓPS₆₋ₓClₓ, as well as combinations thereof.

Examples of solid oxide electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe_{2—x}(PO₄)₃, Li₃PO₄ and Li₃₊ₓPO₄₋ₓNₓ(LiPON).

The solid sulfide electrolyte and solid oxide electrolyte may be glass or crystallized glass (glass ceramic).

Polymer electrolytes include, but are not limited to, polyethylene oxide (PEO) and polypropylene oxide (PPO), and their copolymers.

### Positive Electrode Active Material Layer

The positive electrode active material layers 70a, 70b, 70c, 70d each comprise a positive electrode active material, and optionally a conductive aid and a binder. When the laminated battery of the disclosure is a solid-state battery, it may optionally comprise a solid electrolyte. The solid electrolyte forming the separator layer may be used in this case.

The material of the positive electrode active material is not particularly restricted. Examples for the positive electrode active material include, but are not limited to, heterogenous element-substituted Li—Mn spinel having a composition represented as lithium cobaltate (LiCoO₂), lithium nickelate (LiNiO₂), lithium manganate (LiMn₂O₄), LiCo_{1/3}Ni_{1/3}Mn_{1/3}O₂ and Li₁₊ₓMn_{2-x-y}M_{y}O₄ (where M is one or more metal elements selected from among Al, Mg, Co, Fe, Ni and Zn).

### Positive Electrode Collector

The material used in the positive electrode collectors 80a, 80b, 80c, 80d is not particularly restricted, and any one that can be used as a positive electrode collector in a battery may be employed as appropriate. For example, the material used in the positive electrode collectors 80a, 80b, 80c, 80d may be, but is not limited to, stainless steel (SUS), aluminum, copper, nickel, iron, titanium or carbon, or a conductive resin. The material used for the positive electrode collectors 80a, 80b, 80c, 80d is preferably resistant to oxidation, and is preferably aluminum, for example.

### Conductive Aid

The conductive aid is not particularly restricted. For example, the conductive aid may be, but is not limited to, a carbon material such as VGCF (Vapor Grown Carbon Fibers) or carbon nanofibers, or a metal material.

### Binder

The binder is also not particularly restricted. Examples for the binder include, but are not limited to, materials such as polyvinylidene fluoride (PVdF), butadiene rubber (BR), polytetrafluoroethylene (PTFE) and styrene-butadiene rubber (SBR), or combinations thereof.

### Sealing Material

The sealing material 20 covers the outer side of the stack 10 other than one outermost negative electrode collector 40a of the stack 10. According to the aspect shown in FIG. 1, the one outermost current collector is the negative electrode collector 40a, and the other outermost current collector is the negative electrode collector 40d, but this is not limitative. For example, the one outermost current collector may be a positive electrode collector and the other outermost current collector may be a positive electrode collector, or the one outermost current collector may be a negative electrode collector and the other outermost current collector may be a positive electrode collector.

The parts of the stack 10 other than the one outermost negative electrode collector 40a are encapsulated by the one outermost negative electrode collector 40a through a sealing material 20. The parts other than the one outermost negative electrode collector 40a are the negative electrode collectors 40b, 40c, 40d (excluding the negative electrode collector 40a), the negative electrode active material layers 50a, 50b, 50c, 50d, the separator layers 60a, 60b, 60c, 60d, the positive electrode active material layers 70a, 70b, 70c, 70d and the positive electrode collectors 80a, 80b, 80c, 80d. The one outermost negative electrode collector 40a covers the stack 10 other than the one negative electrode collector 40a, in such a manner that the outer perimeter edge 42d of the other outermost negative electrode collector 40d is covered (encapsulated) by the scaling material 20. Thus, on the side of the other outermost current collector where the active material is not stacked, at least part of the other outermost negative electrode collector 40d extending from the outer perimeter edge 42d is covered by the one outermost negative electrode collector 40a via the scaling material 20.

The sealing material 20 is not particularly restricted, so long as it is a resin that can seal the parts of the stack 10 other than the one outermost negative electrode collector 40a.

Examples of such materials include thermoplastic resins such as polyethylene terephthalate (PET), polypropylene (PP), polyvinylidene chloride (PVDC), polyvinylidene fluoride (PVDF), polycarbonate (PC) or polyether imide (PEI), rubber materials such as acrylonitrile-butadiene rubber (ABR) or butadiene rubber (BR), or non-conductive binders such as epoxy or acrylic binders. Polypropylene (PP) is particularly preferred.

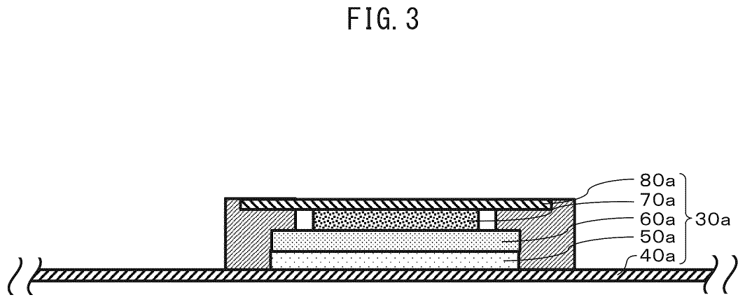

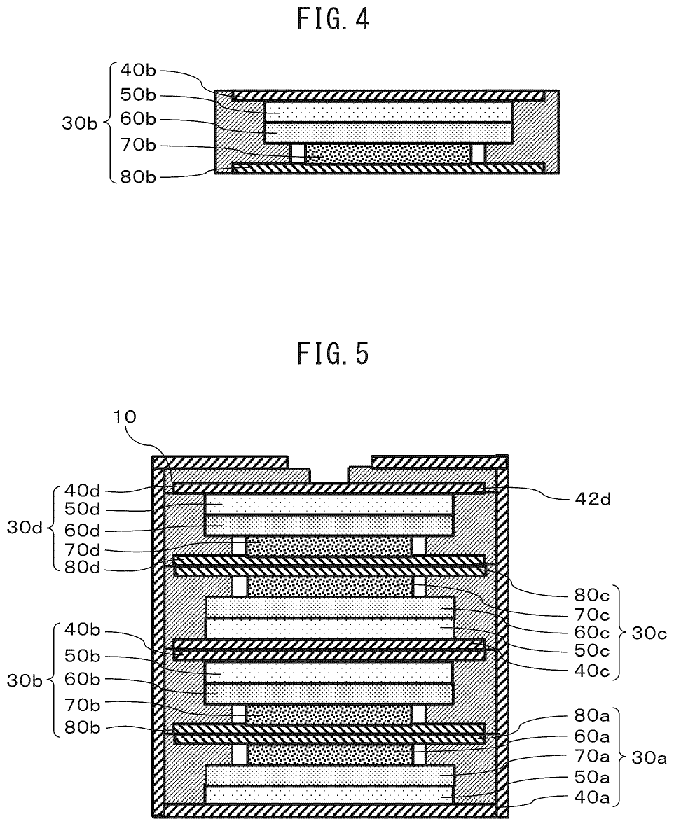

The method for producing a laminated battery as explained above is not particularly restricted, but a typical method will be described with reference to the accompanying drawings. FIG. 2 is a schematic diagram illustrating an example of a method for producing a laminated battery of the disclosure. FIG. 3 is a cross-sectional diagram showing the section near the one outermost negative electrode collector 40d of FIG. 2. FIG. 4 is a cross-sectional diagram showing the section near a negative electrode collector 40b other than the one outermost negative electrode collector 40d of FIG. 2. FIG. 5 is a cross-sectional diagram showing the state just before main fusion of a sealing material 20.

Each of the negative electrode collectors 40a, 40b, 40c, 40d comprises joints 44a, 44b, 44c and a tab part 46. Each of the positive electrode collectors 80a, 80b, 80c, 80d comprises joints 84a, 84b, 84c and a tab part 86. The constituent elements of each of the single batteries 30a, 30b, 30c, 30d and a sealing material 20 are provided between each of the negative electrode collectors 40a 40b, 40c, 40d and each of the positive electrode collectors 80a, 80b, 80c, 80d. The structural material in the state shown in FIG. 2 is heated to temporarily fuse the sealing material 20.

It is then folded in a manner to cause contact between the positive electrode collector 80a of the single battery 30a and the positive electrode collector 80b of the single battery 30b, the negative electrode collector 40b of the single battery 30b and the negative electrode collector 40c of the single battery 30c, and the positive electrode collector 80c of the single battery 30c and the positive electrode collector 80d of the single battery 30d, after which a sealing material 20 is provided on the side of the negative electrode collector 40d of the single battery 30d where the negative electrode active material layer 50d is not stacked, and the outermost negative electrode collector 40a is folded in such a manner as to encapsulate the single batteries 30a, 30b, 30c, 30d which had temporary fusion of the sealing material 20, and to cover the side of the negative electrode collector 40d of the single battery 30d where the negative electrode active material layer 50d is not stacked, via the sealing material 20 (see FIG. 5). The structural material in the state shown in FIG. 5 is heated to produce main fusion of the sealing material 20.

The temperature and time for the temporary fusion and main fusion may be appropriately determined in consideration of the type of resin of the sealing material 20, so as to satisfactorily fuse the sealing material 20. The main fusion temperature is preferably higher than the temporary fusion temperature. The temporary fusion temperature may be 120° C. or higher, 130° C. or higher or 135° C. or higher, and 150° C. or lower, 145° C. or lower or 140° C. or lower, for example. The temporary fusion time may be 30 seconds or longer, 45 seconds or longer or 60 seconds or longer, and 180 seconds or less, 120 seconds or less or 90 seconds or less, for example. The main fusion temperature may be 130° C. or higher, 140° C. or higher or 145° C. or higher, and 160° C. or lower, 155° C. or lower or 150° C. or lower, for example. The main fusion time may be 30 seconds or longer, 45 seconds or longer or 60 seconds or longer, and 180 seconds or less, 120 seconds or less or 90 seconds or less, for example.

When one positive electrode collector and one negative electrode collector are to be shared, they may be shared in the following manner. The first step is to prepare a structural member unit which is the single battery shown in FIG. 3 (a first unit), a structural member unit which is the structural member of the single battery shown in FIG. 4 minus the negative electrode collector (a second unit) and a structural member unit which is the structural member of the single battery shown in FIG. 4 minus the positive electrode collector (a third unit). Sheet materials for the first unit, second unit and third unit are temporarily fused to obtain a first temporary fused unit, a second temporary fused unit and a third temporary fused unit.

The second temporary fused unit, third temporary fused unit and second temporary fused unit are stacked so as to share one negative electrode collector and one positive electrode collector on the first temporary fused unit. They are also folded so as to encapsulate the stack (except for the negative electrode collector of the first temporary fused unit), and to cover the side of the uppermost negative electrode collector where the negative electrode active material layer is not stacked, via the sealing material. They are heated in this state for main fusion of the sealing material.

### Modifications

The production method of the disclosure may incorporate various modifications to the description provided above, in ranges that are still within the scope of the invention as laid out in the Claims. For example, the entire outer side of the laminated battery 100 of FIG. 1 may be further covered with a resin.

### REFERENCE SIGNS LIST

100 Laminated battery
10 Stack
20 Sealing material
30, 30a, 30b, 30c, 30d Single battery
40, 40a, 40b, 40c, 40d Negative electrode collector
42d Outer perimeter edge
44a, 44b, 44c Joint
46 Tab part
50, 50a, 50b, 50c, 50d Negative electrode active material layer
60, 60a, 60b, 60c, 60d Separator layer
70, 70a, 70b, 70c, 70d Positive electrode active material layer
80, 80a, 80b, 80c, 80d Positive electrode collector
84a, 84b, 84c Joint
86 Tab part

1. A laminated battery comprising:
a stack having a plurality of single batteries each with a negative electrode collector, a negative electrode active material layer, a separator layer, a positive electrode active material layer and a positive electrode collector stacked in that order, the batteries being stacked with the negative electrode collectors and the positive electrode collectors in mutual contact, and
a sealing material covering the outer side of the stack other than one outermost current collector of the stack,
wherein at least part of the stack other than at the one outermost current collector is encapsulated by the one outermost current collector through the sealing material, and the one outermost current collector covers the stack other than at the one current collector, so that at least part of the outer perimeter edge of the other outermost current collector is covered by the sealing material.

2. The laminated battery according to claim 1, wherein the negative electrode collectors are connected together, or shared as a single negative electrode collector instead of mutual contact between the negative electrode collectors.

3. The laminated battery according to claim 1, wherein the positive electrode collectors are connected together, or shared as a single positive electrode collector instead of mutual contact between the positive electrode collectors.

4. The laminated battery according to claim 1, wherein the separator layer comprises a solid electrolyte.

5. The laminated battery according to claim 3, wherein the separator layer comprises a solid electrolyte.
